(19) United States
(12) Patent Application Publication
(10) Pub. No.: US 2019/0054407 A1
(43) Pub. Date: Feb. 21, 2019

(54) Particulate Filter-Condensate Separator

(71) Applicant: Wayne Edward Bailey, Fredericksburg, VA (US)

(72) Inventor: Wayne Edward Bailey, Fredericksburg, VA (US)

(21) Appl. No.: 15/998,286

(22) Filed: Aug. 1, 2018

Related U.S. Application Data
(60) Provisional application No. 62/605,631, filed on Aug. 21, 2017.

(51) Int. Cl. B01D 46/00; D06F 58/22; D06F 58/24

(52) U.S. Cl. CPC B01D 46/0031; B01D 46/0005; B01D 46/0047; F26B 25/005; D06F 58/24; B01D 2279/35; D06F 58/22

(57) ABSTRACT

A housing apparatus, as part of a clothes dryer's gaseous fluid exhaust system containing components for maintaining an open restriction free airflow passageway for maintaining the dryer's efficiency and sized to fit within a typical wall cavity of a building.

A means for filtering and removing excess clothes lint, preventing entry of lint particulate into an upper exhaust vent pipe or blend with down falling condensate, both being derived from a clothes dryer's warm moist exhaust airflow.

A diverter to direct the exhaust airflow to a primary exterior location or to a secondary interior location.

A means to separate falling condensate from exhaust airflow and dispose the condensate into an exclusive disposal destination.

The elements of this invention combine to increase the efficiency, longer life and safety of a clothes dryer and its exhaust system by removing lint particulate and separate exhaust airflow from falling condensate within the clothes dryer exhaust system.

REFERENCES CITED

| Document | File Date | Name |
|---|---|---|
| 3,487,624 | January 1970 | Tignanelli Gerald |
| 3,847,175 | November 1974 | Anderson |
| 3,999,304 | December 1976 | Doty |
| 4,338,731 | July 1982 | Shames |
| 4,410,004 | October 1983 | Kifer |
| 4,434,564 | March 1984 | Braggins |
| 4,969,276 | November 1990 | Walsh |
| 5,590,477 | January 1997 | Carfagno |
| 5,628,122 | May 1997 | Spinardi |
| 6,189,228 | February 2001 | Schuette |
| 6,230,418 | April 2000 | Gomulinski |
| 6,419,102 | July 2002 | Harpenau |
| 6,754,976 | July 2003 | Edwards |
| 8,973,282 | March 2015 | Mackay |
| 9,103,589 | September 2013 | Sullivan |
| 9,140,461 | September 2015 | Bailey (self) |
| 13,999,836 | March 2014 | Bailey (self) |
| 2002/0023368 | February 2002 | Beaumont |
| 2011/0167662 | July 2011 | Dittmer |
| 15,530,561 | January 2017 | Bailey (self) |
| 62,605,631 | August 2017 | Bailey (self) |

### BACKGROUND

An estimated 16,800 reported U.S. non-confirmed or confirmed home structure fires involved clothes dryers resulting in over 50 civilian deaths, over 300 civilian injuries and over $200 million in direct property damage.

A clothes dryer works by forcing moist, warm air through a turning drum. Wet clothes placed in the drum are than dried by moving hot air. It is possible for a full load of wet clothes to contain as much as 1.5 gallons of water.

Lint, consisting mostly of small fibers from the clothes and debris in or on the clothes, is created as the clothes tumble in the drum.

While much of the lint is trapped by the dryer's filter, it is also carried through the vent system along with the moist air. Lint accumulated in the dryer vent can be highly combustible, additionally, lint leads to reduced airflow within the vent and can cause blockage and overheating or a potential fire hazard.

When the warm, moist dryer air within the vent reaches an unheated space such as a garage, attic or the outside atmosphere, colder temperatures cause the relative humid air to condense back to liquid form (condensate) within the vent pipe. This condensate (water) can drain back into the clothes dryer or settle in a low point of a dryer vent hose causing blockage, causing the dryer to overheat, resulting in reduced dryer efficiency or fire.

Clothes dryer vent pipes are often installed with little consideration to problems of condensate flowing downward into the clothes dryer or filling the flexible dryer vent hose at its low point. The low point can unintentionally create a water trap which blocks the airflow from the dryer causing the dryer to overheat, loose efficiency or cause fire damage.

Another issue with clothes dryers is that their filters generally catch less than 80% of the lint produced, this means that over many drying cycles large amounts of lint can accumulate in the dryer's vent system.

Blending of the excess lint from the dryer with the condensate can produce a slurry mix, which can build inside the exhaust vent pipe. Over time this slurry can form a mass creating additional blockage problems.

Since most of a dryer's vent piping is hidden inside walls and often poor installation standards and/or improper duct materials added to the lack of routine maintenance, it is estimated that there are thousands of house fires annually associated with clothes dryers.

Another deficiency with current exhaust vents is the inability to separate excess lint from the condensate before blending develops.

According to U.S. Customer Product Safety Commission research, a 75% blocked dryer exhaust duct elevates the exhaust air temperature of the average electric clothes dryer 89% more than its normal temperature with an unblocked duct.

### FIELD OF INVENTION

The present invention relates to clothes dryer's exhaust system, and more particularly to filtering lint particulate from the clothes dryer's exhaust airflow and separating from falling condensate to prevent blending into a sludge.

The airflow filter intercepts the lint particulate from the exhaust airflow before the exhaust airflow comes in contact with the falling condensate. By removing the lint particulate from the exhaust airflow before the airflow reaches the falling condensate, the risk of lint and condensate blending into a sludge is eliminated.

After the lint has been filtered from the exhaust airflow, the clean exhaust airflow is directed past and separated from the falling condensate.

The exhaust airflow is removed from the gaseous fluid exhaust system through one of two outlet ports.

After separation, the airflow is directed out of the airflow exhaust system through a chosen outlet port and the condensate is directed out through a separate, dedicated condensate port to be disposed of.

In addition, the falling condensate is prevented from entering the clothes dryer and causing damage or from entering the clothes dryer flexible vent hose and causing blockage.

### DESCRIPTION OF PRIOR ART

Prior art does not address the problem of falling condensate and excess lint particulate from an exhaust airflow producing machine such as a clothes dryer particularly the separation and disposal of the condensate from lint.

Generally, clothes dryers do not filter 100% of the lint particulate produced during a typical drying cycle. Additionally, a typical load of clothes cycling through a clothes dryer will produce over 1.5 gallons of water, which is blown upward into the dryer exhaust vent pipe in the form of a high moisture content water vapor.

As the water vapor continues through the exhaust pipe the water vapor may turn to condensate and flow back down to the clothes dryer. Additionally, the condensate can blend with the lint particulate, creating a slurry which can cause blockage in the dryer vent.

A blockage in the dryer vent can cause the dryer to underperform or overheat and possibly cause a fire.

The present invention comprises new and novel solutions combined to address the need to prevent condensate from entering a clothes dryer and preventing lint intrusion into a dryer exhaust system and for preventing the blending of condensate and lint particulates and directing their separate disposal.

### SUMMARY OF THE INVENTION

This invention has particular application to homes and other dwellings allowing architects, builders and home owners greater leeway in designing more efficient laundry room designs. Clothes dryers may be positioned for best use of floor space while a higher degree of fire safety within the home.

In accordance with the present invention, the double airflow filter, drain assembly and lint particulate separator within a housing of a gaseous fluid exhaust system provides multiple unique features as part of an exhaust airflow system.

A primary object of the invention is to remove access lint particulate from the exhaust airflow by filtration before the exhaust airflow comes in contact with condensate.

Another primary object of the invention is to filter and remove the lint particulate originating from a clothes dryer's exhaust airflow to prevent lint particulate from blending with falling condensate, which can form within a gaseous fluid exhaust system and to prevent the condensate from entering the exhaust producing dryer, and to dispose the condensate out of the gaseous fluid exhaust system to a designated drain.

The filtered exhaust airflow continues through the non-restricting airflow channel and is separated from the condensate by an airflow diverter and is directed to one of two exit outlets as selected by the dryer operator.

The exhaust airflow is directed to a selected outlet within a diverter by blocking the exhaust airflow to the unselected outlet and directing the exhaust airflow to exit through the selected outlet.

The airflow diverter additionally channels the exhaust airflow upward past falling condensate creating a separation of the upward flowing exhaust airflow and the downward flowing condensate.

It is another object of the invention to provide an operational zone located in the upper compartment of the housing for placement of operational components comprising; access openings, viewing windows, an airflow diverter, and an airflow monitor/alarm.

It is another object of the invention to provide access openings for entry into the housing for cleaning and maintenance, additionally, the access openings are sealable with removable clear viewing panels that serves as observation windows for monitoring conditions during operations. The access openings and viewing windows are located within the operational zone for efficient operations and accessibility.

It is another primary object of the invention to provide an enlarged, removable double screen airflow filter with a folding design to fit into a pocket within the housing to provide added filter surface.

It is another object of the invention to segregate the exhaust airflow from falling condensate, to direct the exhaust airflow to one of two designated exhaust outlets and direct the falling condensate to a separate dedicated outlet for disposal.

It is another object of the invention to block entry of exhaust airflow into the condensate drain with an inverted drain loop (trap) which holds an amount of fluid so as to block upward entry of sewer gasses.

It is another object of the invention for the housing to be dimensioned to be installed within a typical stud wall or onto the surface of a typical stud wall and provide continues unrestricted airflow within the housing. The housing being dimensioned to be 3.5 inch depth, to accommodate interior wall installations. Airflow received from a 4 inch round clothes dryer vent is converted to a 3.5 inch by 4 inch or larger rectangular passageway for unrestricted airflow through the housing.

Within the housing, airflow passageway capacity equals or exceeds 100% of airflow capacity produced by the clothes dryer's 4 inch round flexible hose.

It is another object of the invention to provide an airflow monitor/alarm to record and signal any issues arising from blockage, overheating, reduced airflow volume or increased airflow pressure within the exhaust airflow system as a result of blockage due to the build-up of lint particulate, condensate or the blending of both into a slurry.

It is another object of the invention to provide containment of the flexible dryer hose within the lower storage compartment of the housing with a moveable retaining gate for securing the dryer's flexible vent hose in multiple non-kinking positions for storage and efficient connections for the clothes dryer flexible hose.

It is another object of the invention to provide positioning of the airflow filter, condensate filter unit, airflow diverter, access openings and observation windows in an extended upper compartment which extends forward for additional space and ease of accessibility. The extended upper compartment allows larger filter units and may extend above a clothes dryer.

Additionally, a fan is positioned within the housing or exhaust pipe for drawing airflow from the airflow source and delivering the airflow to its designated exit port

To the accomplishment of the foregoing and related ends, the invention, then, comprises the features here. The present invention in after fully describe and particularly pointed out in the claims, the following description and the annexed drawings setting forth in detail certain illustrative embodiments of the invention, these being indicative, however, of but some of the various ways in which the principals of the invention may be employed.

It is a further object of the invention to provide improved elements and arrangements thereof for the purposes described which is inexpensive, dependable and fully effective in accomplishing its intended purposes.

These and other objects of the present invention will become readily apparent upon further review of the following specifications and drawings.

### BRIEF DESCRIPTION OF DRAWINGS

There are shown in the drawings embodiments which are presently preferred, it being understood, however, that the invention is not limited to the precise arrangements and instrumentalities shown, wherein:

FIG. 1 Illustrates a front elevation view of the Housing 1 of this invention with the upper compartment of housing 3 extended forward to accommodate particulate filter-condensate separator 28, access openings 39, viewing windows 40, airflow pressure monometer/alarm 41, diverter door with sloped top 44, and top wall of housing 8.

FIG. 2 Illustrates a front elevation view of the housing 1, with front wall of upper compartment of housing 11, lower compartment of housing 2, airflow 25, condensate drain trap 23, retaining gate in open position 13, retaining gate hinges 15, retaining gate latch 16, retaining gate adjustable cross bars 14, upper compartment floor/lower compartment ceiling 20.

FIG. 3 Illustrates a front elevation view of housing 1, with front wall of upper compartment of housing 11, removed to illustrate first airflow directional vane 27, first airflow channel 26, airflow 25, sloped basin floor 21, condensate drain 22, particulate filter-condensate separator 28, second airflow directional vane 38, airflow deflector 35, airflow exhaust pipe 45, primary airflow exit port 43, secondary airflow exit port 42, bottom wall of housing 4, left side wall of housing 5, right side wall of housing 6, housing attachment flange 9,

FIG. 4 Illustrates a front elevation view of housing 1, with front wall of upper compartment of housing 11, installed to illustrate the placements of particulate filter-condensate separator 28, filter frame 28a, airflow flexible vent duct 17, airflow fan 46. Illustrated in lower compartment of housing 2, are condensate disposal hose 24, attachment holes of housing flange 10, retaining gate in closed position 12.

FIG. 5 illustrates a front elevation view of the upper compartment with front wall of upper compartment of housing 11 removed, first filter screen 28b, second filter screen 28c, first and second filter screen surrounds 28d, condensate weep holes 28g, sloped lower guide 31, sloped insert key 33, second airflow channel 37, diverter door handle 44a, diverter door hinges 44b, diverter door, down position 44d, condensate C, condensate drip edge 49, condensate, (within second airflow channel) C-1, airflow fan 46, airflow exhaust pipe 45, diverter assembly 47.

FIG. 6 Illustrates a front elevation with front wall of upper compartment of housing 11, removed to reveal diverter door with sloped top 44, diverter door, up position 44e, blocking airflow through primary airflow exit port 43, diverter door air seal 44c, condensate C, directed into condensate drain channel 48, condensate (within condensate drain channel) C-2, vent duct adapter 19, sloped basin floor 21, condensate drain 22, sloped bottom of filter frame 32, sloped lower guide 31, sloped bottom of filter frame 32, sloped insert key 33, diverter assembly 47.

FIG. 7 Illustrates a detailed view of particulate filter-condensate separator 28, filter frame 28a, first filter screen 28b, second filter screen 28c, first and second filter screen surrounds 28d, first and second filter screen hinges 28e, filter frame lower guide 30, sloped lower guide 31, sloped bottom of filter frame 32, sloped insert key 33, sloped basin floor 21, condensate drain 22, airflow deflector 35, second airflow channel 37, second airflow directional vane 38, upper compartment floor/lower compartment ceiling 20.

FIG. 8 Illustrates a front elevation of housing 1, with an alternate bottom port and alternate airflow 25, configuration with housing vent knockout 18, located in bottom wall of housing 4, to allow passage of airflow 25, first airflow directional vane 27, and third directional vane 36, directs airflow 25, to the alternate bottom port through housing vent knockout 18, particulate filter-condensate separator 28, separates first airflow channel 26, from second airflow channel 37, airflow flexible vent duct 17, is attached to vent duct adapter 19, to deliver airflow 25, into upper compartment of housing 3.

FIG. 9 Illustrates a front elevation of housing 1, with first airflow directional vane 27, and third directional vane 36, directing airflow 25, through particulate filter-condensate separator 28, into alternate airflow exhaust pipe 45,

FIG. 10 Illustrates a front elevation of lower compartment of housing 2, with airflow flexible vent duct 17, fitted within lower compartment of housing 2, and organized by retaining gate in closed position 12, positioned by retaining gate adjustable cross bars 14.

FIG. 11 Illustrates housing vent knock-outs 18, on each side of lower compartment of housing 2, gate hinge attachment 34, secures retaining gate in closed position 12, retaining gate adjustable cross bars 14, airflow flexible vent duct 17, within lower compartment of housing 2.

FIG. 12 Illustrates particulate filter-condensate separator 28, comprising filter frame 28a, first filter screen 28b, second filter screen 28c, first and second filter screen surrounds 28d, first and second filter screen hinges 28e, filter frame handle 28f, condensate weep holes 28g, and sloped bottom of filter frame 32.

FIG. 13, Illustrates the left side wall of housing 5, with diverter door, down position 44d, blocking second airflow exit port 42, allowing condensate C, to fall from airflow exhaust pipe 45, through the primary airflow exit port 43, resulting in condensate C, becoming condensate C-1, (within second airflow channel, 37), diverter door handle 44a, diverter door hinge 44b, airflow 25, flows upward through the open primary airflow exit port 43, diverter door handle 44a, is attached to diverter door with sloped top 44, for positioning diverter door with sloped top 44, in either diverter door, down position 44d, or diverter door, up position 44e.

FIG. 14 Illustrates the left side wall of housing 5, with diverter door with sloped top 44, in the diverter door, up position 44e, blocking primary airflow exit port 43, resulting in airflow 25, being diverted into secondary airflow exit port 42, diverter door air seal 44c, adds air tightness and condensate C, is blocked from entering primary airflow exit port 43.

FIG. 15 Illustrates an example of an airflow source CD, tightly against the lower compartment of housing 2, and upper compartment of housing 3, extending forward as illustrated by upper compartment floor/lower compartment ceiling 20, and front wall of upper compartment 11, and top wall of housing 8, primary airflow exit port 43, airflow exhaust pipe 45, rear wall of housing 7, illustrates this arrangement.

FIG. 16 Illustrates a front elevation view of housing 1, being in a free standing configuration, adjacent to an airflow source CD, with airflow 25, flowing through housing vent knockout 18, into vent duct adapter 19, airflow pressure manometer/alarm 41, is positioned in upper compartment of housing 3, particulate filter-condensate separator 28, airflow exhaust pipe 45, primary airflow exit port 43, and condensate drain 22 is illustrated.

FIG. 17 Illustrates the right side of housing 6, with housing 1, elevated 14 inches of the floor to comply with a pedestal design airflow source CD, upper compartment of housing 3, extends over and above airflow source CD, vent duct adapter 19, is repositioned to mate with airflow source CD, lower compartment of housing 2, is adjacent to airflow source CD, bottom wall of housing 4, front wall of upper compartment 11, rear wall of housing 7, define the housing 1.

FIG. 18 Illustrates a front elevation of housing 1, positioned to the rear of an airflow source CD, condensate drain trap 23, feeds into condensate disposal hose 24, which feeds into waste pipe, airflow exhaust pipe 45, maintains a constant grade to prevent a water trap, which can block air flow 25, through airflow exhaust pipe 45.

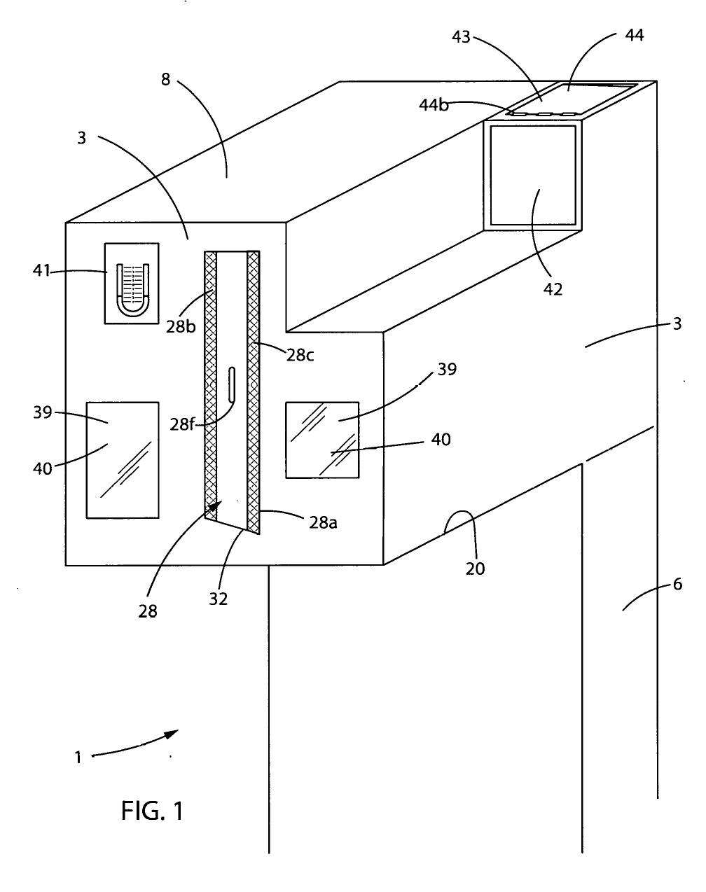

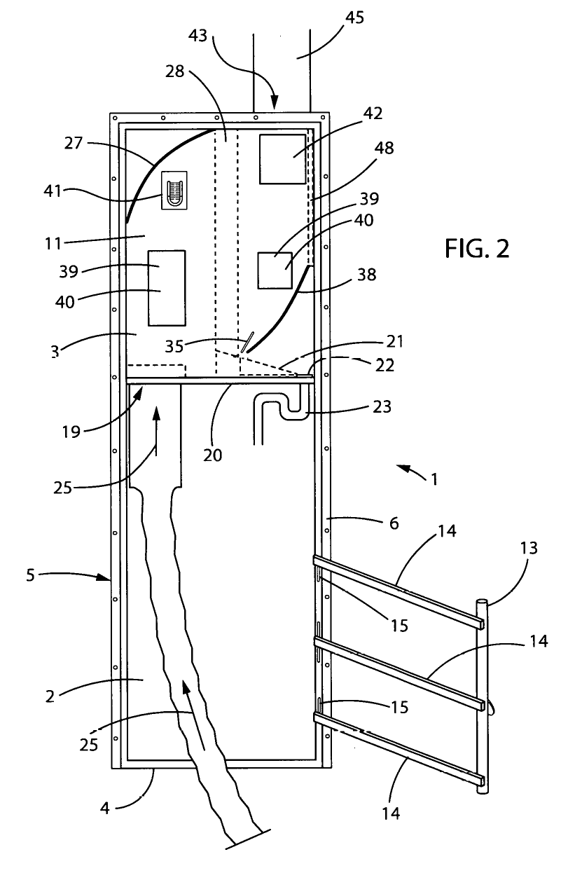

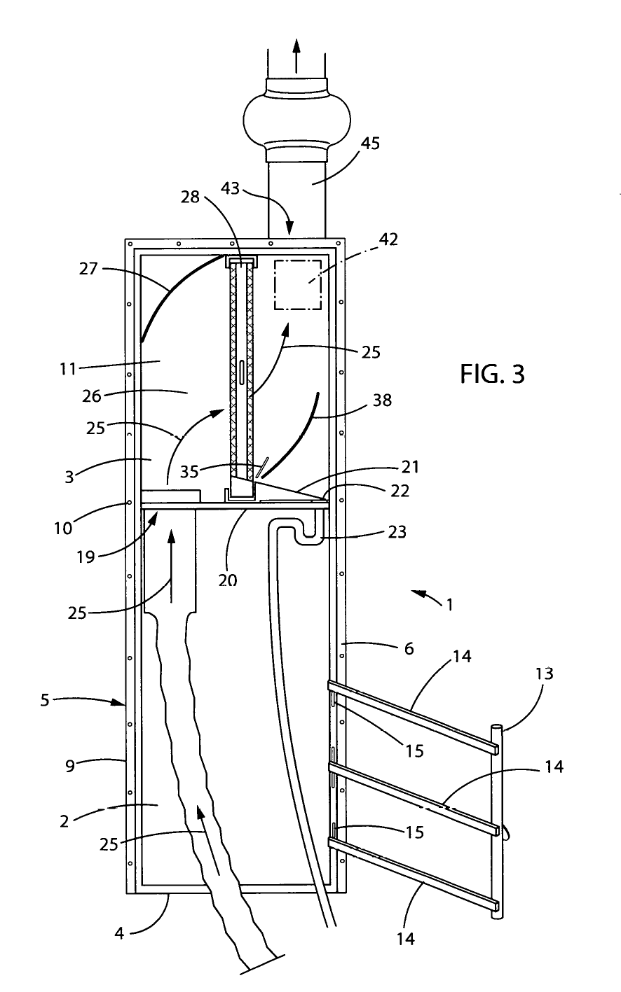

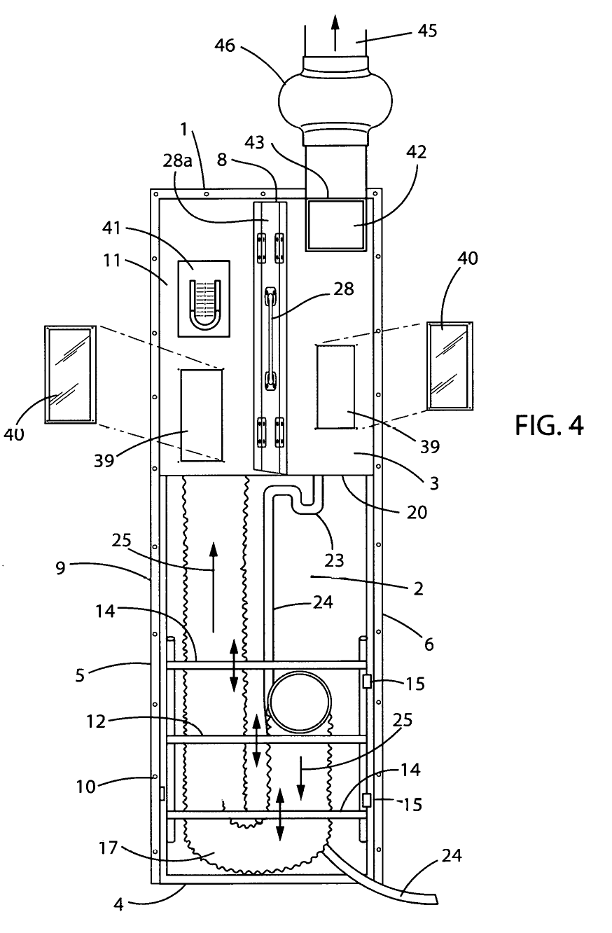

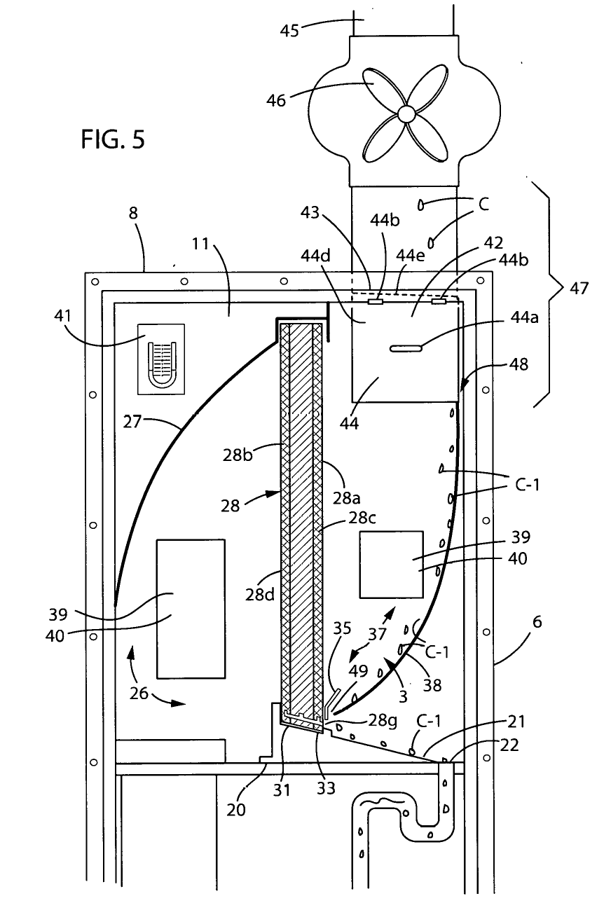

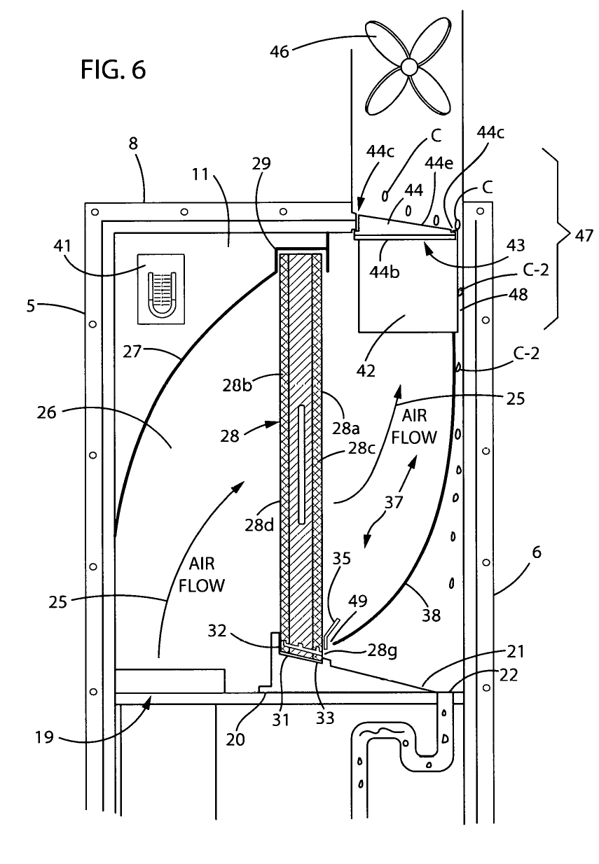

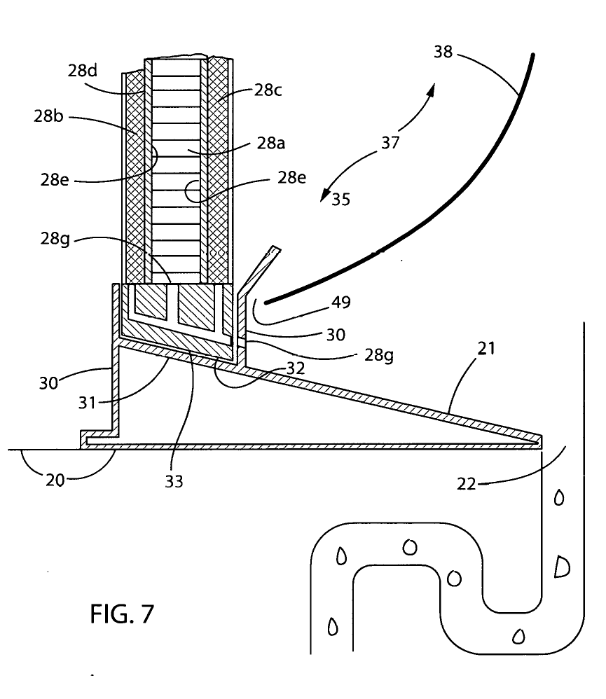

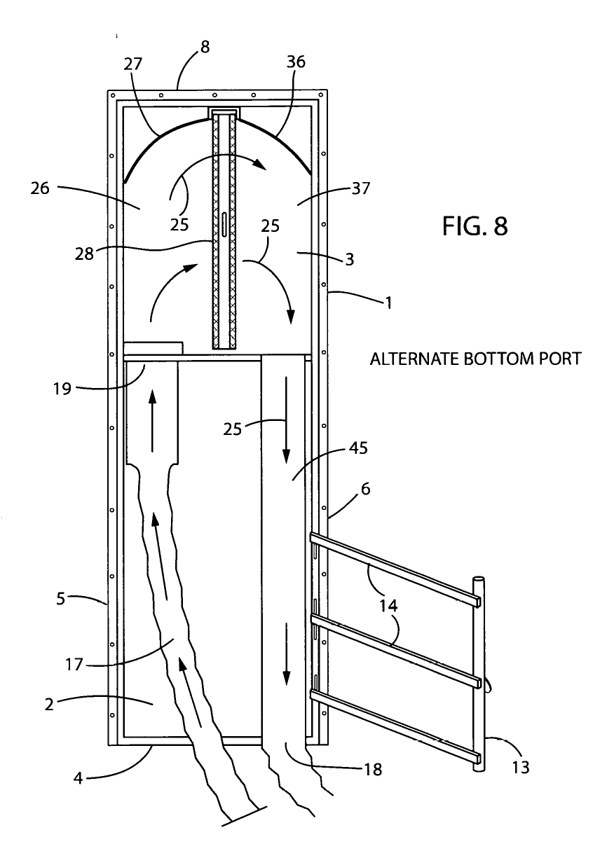

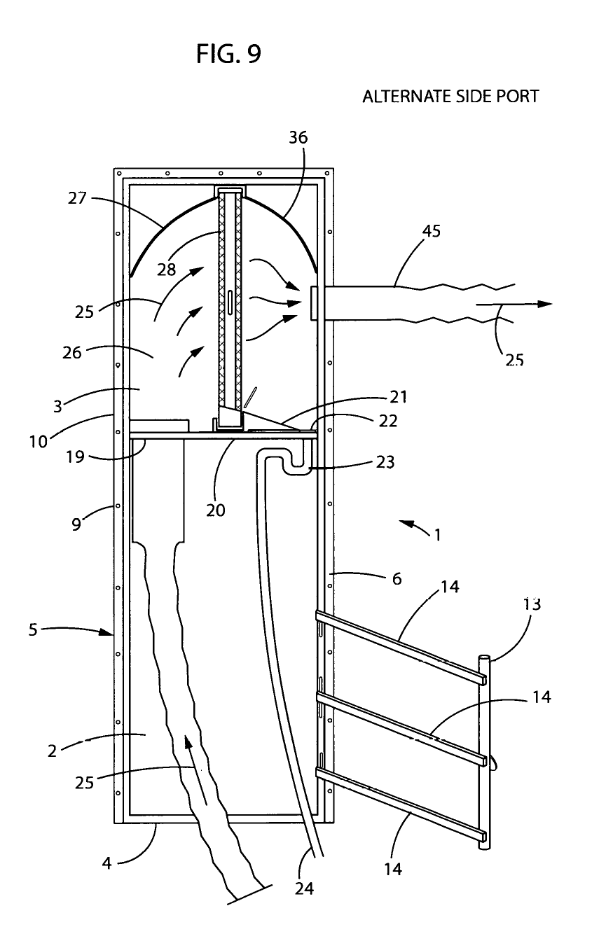

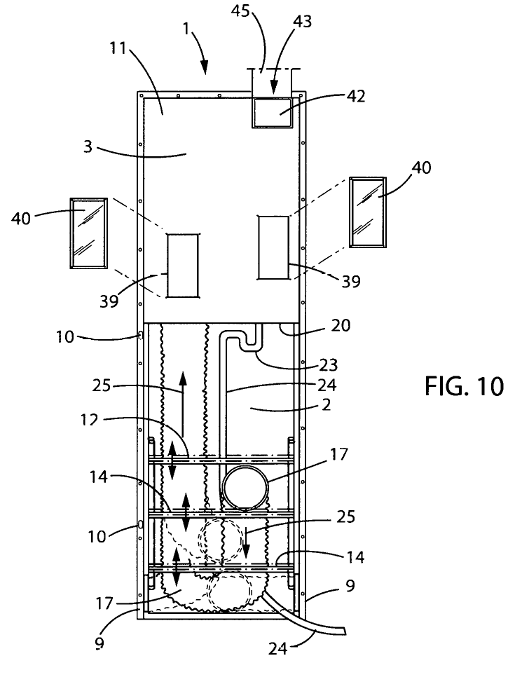

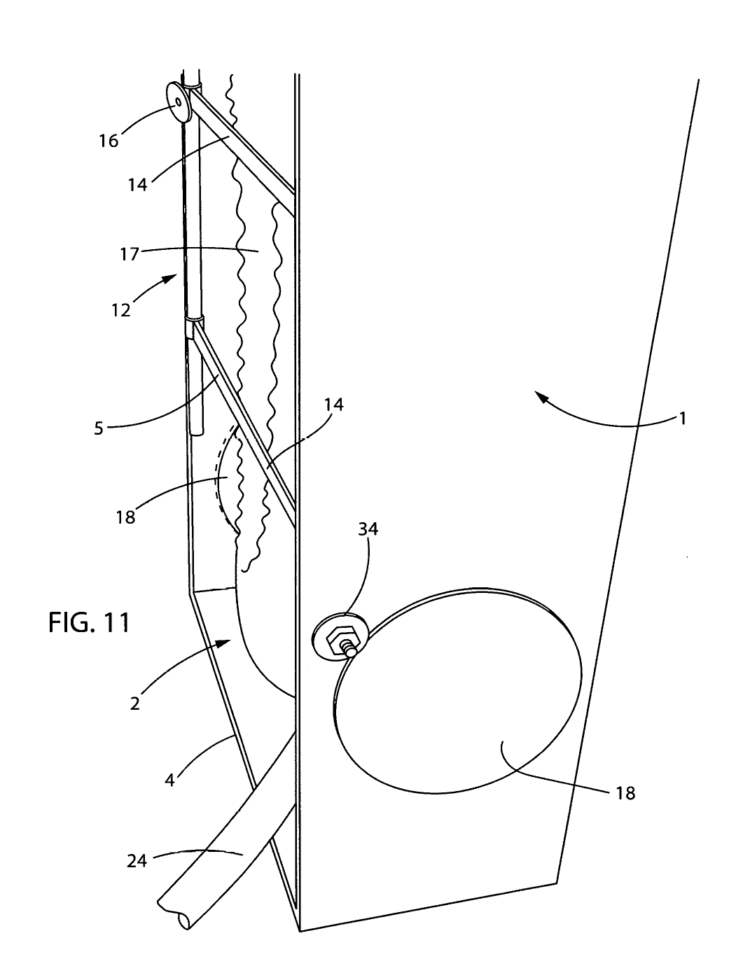

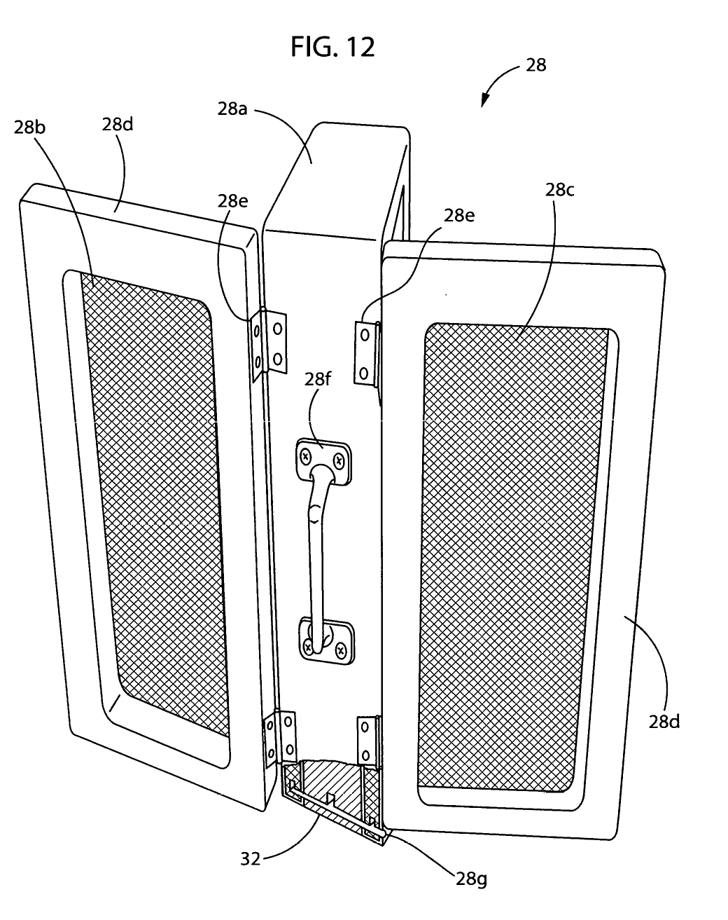

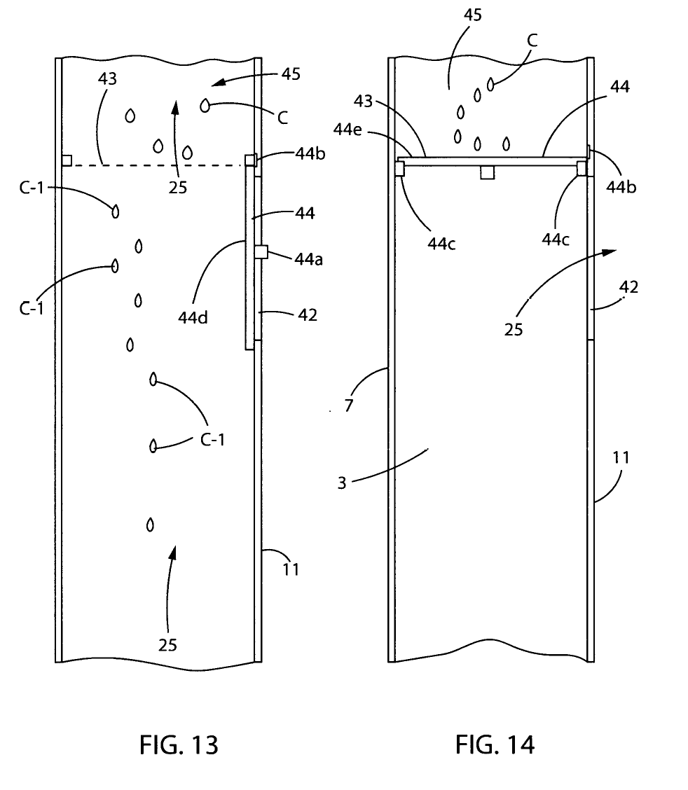

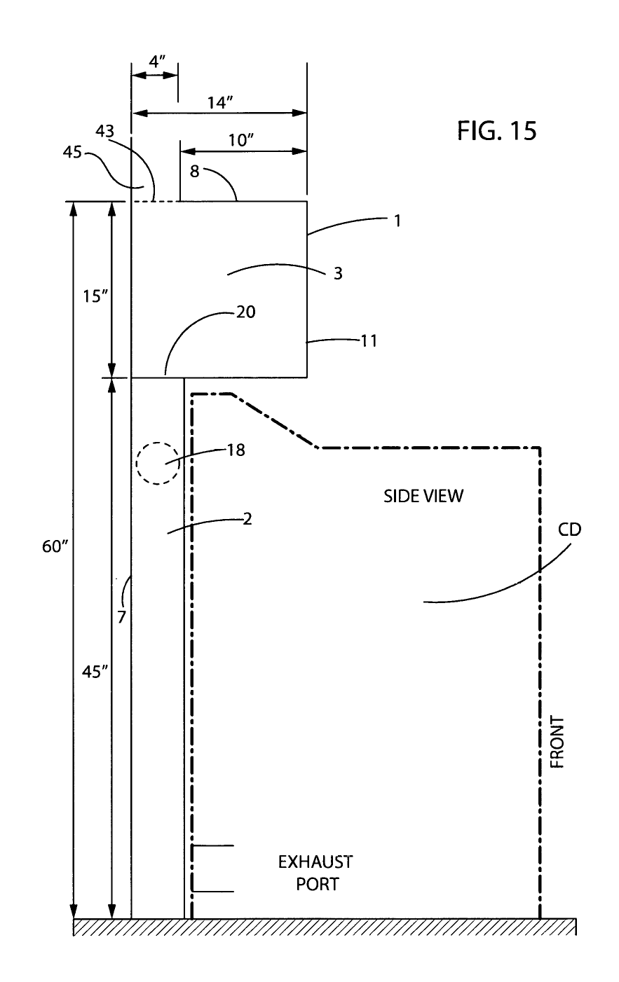

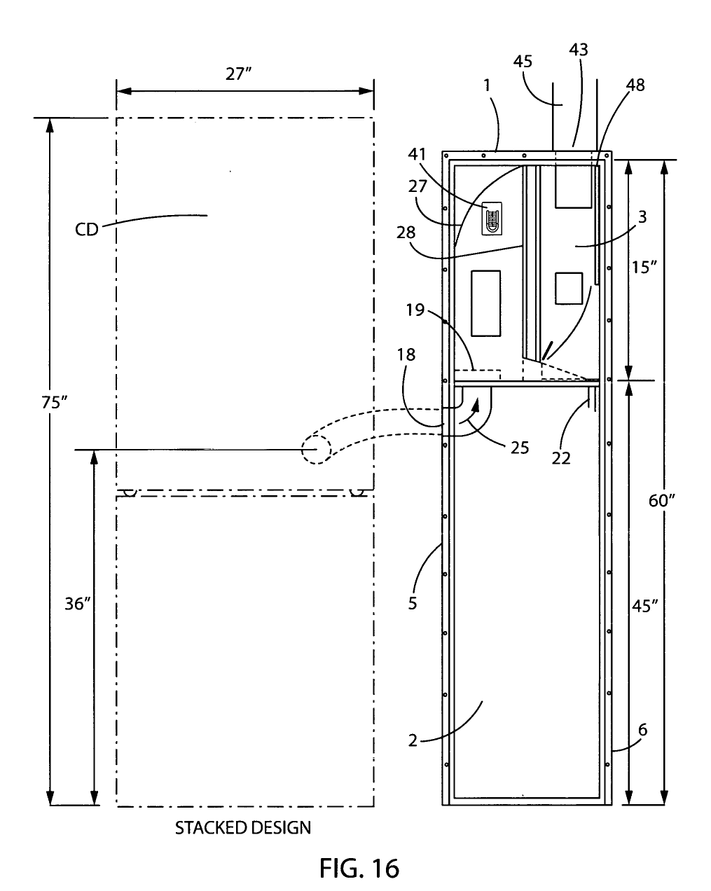

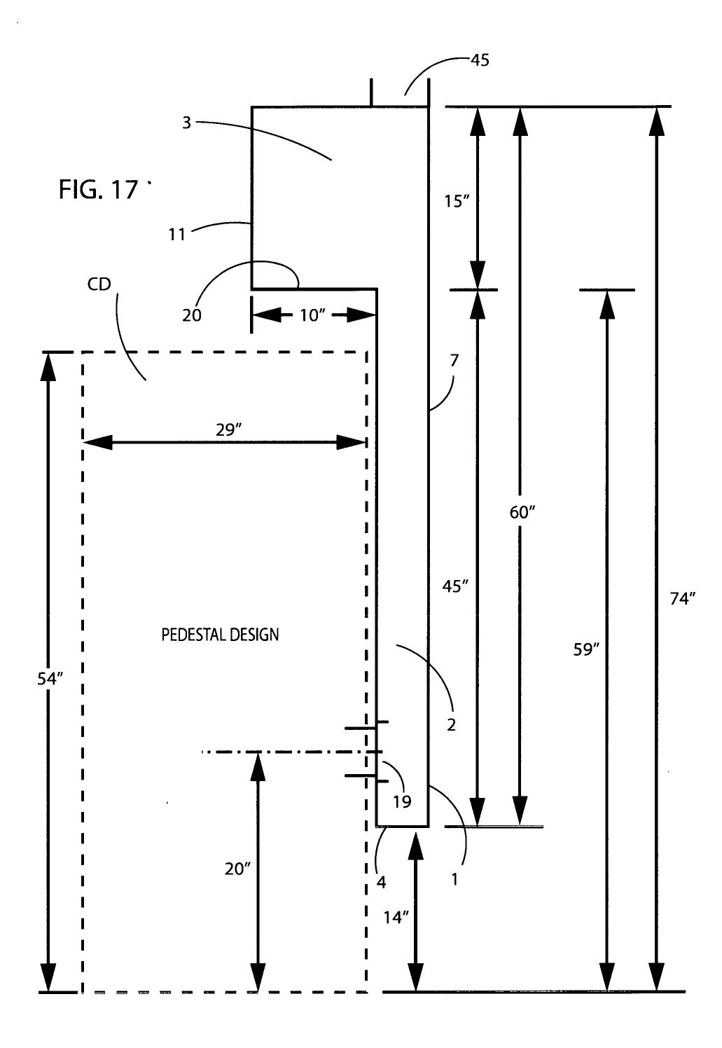

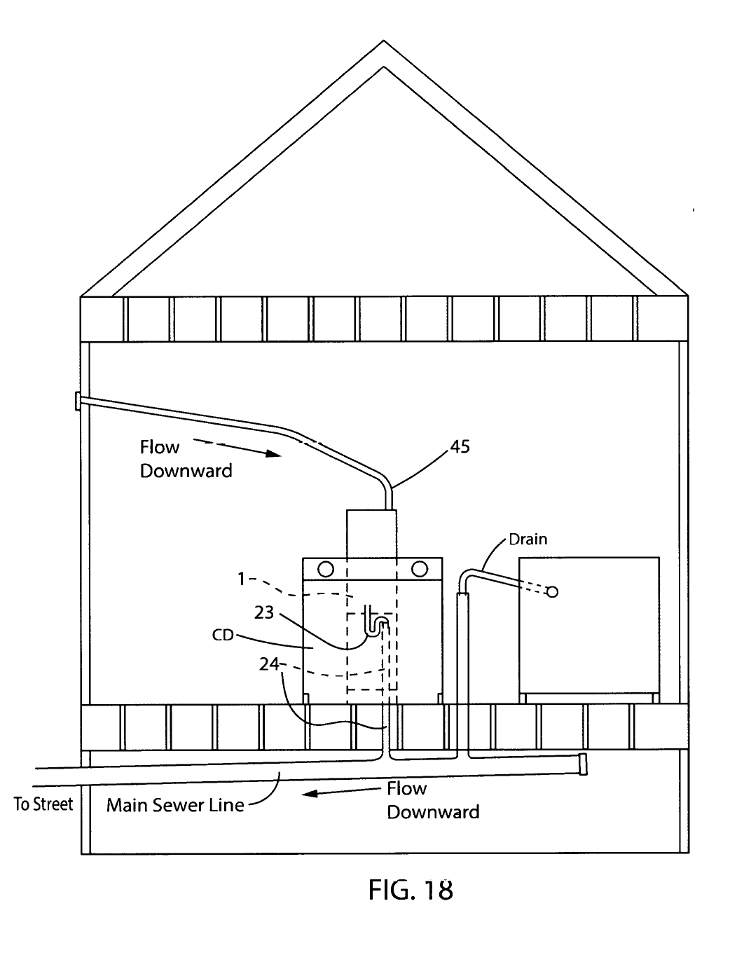

### DESCRIPTION OF PREFERRED EMBODIMENTS

### 1. Housing,

The body containing the components which are listed below including the airflow exhaust pipe 45, and airflow fan 46, which are attached to the housing 1, are part of this application. The housing 1, is designed for installation within a typical 16″ OC stud wall or optionally, on the surface of a typical wall.

The housing 1, receives airflow 25, from an airflow flexible vent duct 17, and after processing expels the airflow 25, through the primary airflow exit port 43, or through the secondary airflow exit port 42.

The housing 1, has a bottom wall of housing 4, left side wall of housing 5, right side wall of housing 6, rear wall of housing 7, top wall of housing 8, and housing attachment flange 9, with attachment holes of housing flange 10.

2. Lower compartment of housing,

The lower compartment of housing 2, is substantially open and contains the airflow flexible vent duct 17, which is secured by a retaining gate in closed position 12, the retaining gate in closed position 12, has retaining gate adjustable cross bars 14. Additionally, a condensate drain trap 23, and condensate disposal hose 24, are located within the lower compartment of housing 2.

3. Upper compartment of housing,

The upper compartment of housing 3, substantially closed by the front wall of upper compartment 11, contains a vent duct adapter 19, first airflow channel 26, first airflow directional vane 27, particulate filter-condensate separator 28, second airflow channel 37, second airflow directional vane 38, secondary airflow exit port 42, primary airflow exit port 43, diverter door with sloped top 44, condensate drain channel 48, airflow exhaust pipe 45, airflow fan 46, condensate drip edge 49, sloped basin floor 21, condensate drain 22, which connects to a condensate drain trap 23, in the lower compartment of housing 2, additionally, access openings 39, viewing windows 40, airflow pressure manometer/alarm 41, condensate weep holes 28g, and an upper compartment floor/lower compartment ceiling 20.

4. Bottom wall of housing,

The bottom wall of housing 4, serves as base and is connected to the rear wall of housing 7, left side wall of housing 5, and right side wall of housing 6.

5. Left side wall of housing,

The left side wall of housing 5, is connected to the bottom wall of housing 4, rear wall of housing 7, and top wall of housing 8, and connected to the front wall of upper compartment 11.

6. Right side wall of housing,

The right side wall of housing 6, is connected to the bottom wall of housing 4, rear wall of housing 7, top wall of housing 8, and front wall of upper compartment 11.

7. Rear wall of housing

The rear wall of housing 7, is connected to the bottom wall of housing 4, connected to the top wall of housing 8, connected to the left side wall of housing 5, and connected to the right side of housing 6.

8. Top wall of housing,

Top wall of housing 8, is connected to the rear wall of housing 7, left side wall of housing 5, right side wall of housing 6, and front wall of upper compartment 11.

9. Housing attachment flange,

The housing attachment flange 9, is connected to the left side wall of housing 5, right side all of housing 6, and top wall of housing 8. The housing attachment flange 9, is turned at a right angle to the housing walls and extended outward for securing the housing 1, to wall studs.

10. Attachment holes of housing flange,

The attachment holes of housing flange 10, of the housing attachment flange 9, are for receiving attachment screws to secure the housing 1, to a typical wall stud.

11. Front wall of upper compartment,

The front wall of upper compartment 11, covers and contains the upper compartment of housing 3, sealing it from air and condensate leakage with openings for the particulate filter-condensate separator 28, access openings 39, viewing windows 40, secondary airflow exit port 42, and airflow pressure manometer/alarm 41.

12. Retaining gate in closed position,

The retaining gate in closed position 12, is located and attached to the side wall of housing 5 or 6 of the lower compartment of housing 2, for retaining and efficiently securing the Airflow Flexible Vent Duct 17, within the Lower Compartment of Housing 2.

13. Retaining gate in open position,

The retaining gate in open position 13, allows servicing and efficient placement of the airflow flexible vent duct 17, and for connecting the airflow flexible vent duct 17, to the Vent duct adapter 19.

14. Retaining gate adjustable cross bars,

The Retaining gate adjustable cross bars 14, allows multiple positions for the airflow flexible vent duct 17, to be efficiently placed within the lower compartment of housing 2, for maximum airflow 25, efficiency and connections to airflow sources CD.

15. Retaining gate hinges,

The retaining gate hinges 15, are attached to the side wall of housing 5 or 6 and attached to the retaining gate in closed position 12, for operating the retaining gate in closed position 12, to the retaining gate in open position 13.

16. Retaining gate latch,

The retaining gate latch 16, is for securing the retaining gate in closed position 12, to the housing 1.

17. Airflow flexible vent duct,

The airflow flexible vent duct 17, is a hollow enclosed conduit with the first end connected to the airflow source CD, and the second exit end connected to the vent duct adapter 19 and is located within the lower compartment of housing 2.

18. Housing vent knockouts,

The housing vent knockouts 18, are located on the left side wall of housing 5, right side wall of housing 6, bottom side wall of housing 4, and rear side wall of housing 7, are indentations in the surface for custom entry and connection of the airflow flexible vent duct 17, into the housing 1.

19. Vent duct adapter, (round transition to rectangular)

The vent duct adapter 19, is located within the upper compartment floor/lower compartment ceiling 20, and is round on the first incoming end to connect with the round end of the airflow flexible vent duct 17, and transitions to a rectangular shape on the second outgoing end so as to accommodate 100% or greater of airflow 25, flowing through the airflow flexible vent duct 17, and meet the measurement and dimension requirements of the housing 1.

20. Upper compartment floor/lower compartment ceiling,

The upper compartment floor/lower compartment ceiling 20, Located between the lower compartment of housing 2, and the upper compartment of housing 3, provides a separation wall between the upper compartment of housing 3, and the lower compartment of housing 2, that contains the vent duct adapter 19, and the condensate drain 22. In addition, the upper compartment floor/lower compartment ceiling 20, serves as the bottom wall of the upper compartment of housing 3, for sealing the upper compartment of housing 3.

21. Sloped basin floor,

The sloped basin floor 21, is Located within the upper compartment of housing 3, positioned on and above the upper compartment floor/lower compartment ceiling 20, for receiving condensate C-1 from the second airflow channel 37, and additionally receive condensate C-2 from the condensate drain channel 48, condensate C-1 and condensate C-2, derives from condensate C, and originates from the airflow exhaust pipe 45.

The sloped basin floor 21, is sloped from the filter frame lower guide 30, downward to the condensate drain 22, for condensate C-1 and condensate C-2, to flow to the condensate drain 22.

22. Condensate drain,

The condensate drain 22, is located within the upper compartment floor/lower compartment ceiling 20, with the first upper end located at the lowest point of the sloped basin floor 21, for Receiving condensate C-1, and condensate C-2, from the sloped basin floor 21, and for draining the condensate C-1, and condensate C-2, out of the upper compartment 3, into the condensate drain trap 23, which is located beneath the condensate Drain 22.

23. Condensate drain trap,

The condensate drain trap 23, is connected to and beneath the condensate drain 22, for stopping-airflow 25, from entering from above, and prevent entry of sewer gases which may derive from the condensate disposal hose 24, below, which may develop from a connection with a sewer pipe.

The condensate drain trap 23, is designed to retain water (condensate C), in a looped “S” or “P” shaped trap configuration for blocking sewer gas passage through the condensate drain rap 23.

24. Condensate disposal hose,

The condensate disposal hose 24, connects to the condensate drain trap 23, on its incoming end and is connected to an outlet on the outgoing end for transporting condensate C, which drains from the condensate drain trap 23.

### 25. Airflow,

The airflow 25, is produced by an airflow source CD, which contains particulate and moisture content, flows through the round airflow flexible vent duct 17, into the vent duct adapter 19, an expanded rectangular outlet which carries the airflow 25, into the first airflow channel 26, with no loss of airflow 25, volume.

The first airflow channel 26, contains a first airflow directional vane 27, which directs the airflow 25, to change from an upward direction to a lateral direction causing the airflow 25, to flow laterally into and thru the Windward side of the particulate filter-condensate separator 28, and exit through the Leeward side of the particulate filter-condensate separator 28, into the second airflow channel 37. Inside the second airflow channel 37, the airflow 25, is redirected again from the lateral direction to an upward direction by the second directional airflow vane 38. The upward flowing airflow 25, exits the second airflow channel 37, through either the primary airflow port 43, or through the secondary airflow port 42, depending on the up or down position of the diverter door with sloped top 44. As the airflow 25, enters the second airflow channel 37, from the particulate filter-condensate separator 28, the lateral force of the airflow 25, drives the falling condensate C-1, away from the particulate filter-condensate separator 28, thus repelling the condensate C-1, from entering the first airflow channel 26, and entering the airflow flexible vent duct 17. Additionally, the lateral force of the airflow 25, drives the falling condensate C-1, into the surface of the second airflow directional vane 38, which serves as a surface for the condensate C-1, to cling to as the condensate C-1, flows downward to the condensate drip edge 49.

26. First airflow channel,

The first airflow channel 26, is located within the upper compartment of housing 3, above the vent duct adapter 19, and on the windward side of the particulate filter-condensate separator 28. The first airflow channel 26, receives up-flowing airflow 25, from the vent duct adapter 19, and the airflow 25, is redirected laterally by the first airflow directional vane 27, into the particulate filter-condensate separator 28.

27. First airflow directional vane,

The first airflow directional vane 27, is located within the first airflow channel 26, for redirecting up-flowing airflow 25, coming from the vent duct adapter 19, to a lateral direction into the particulate filter-condensate separator 28.

The curvature shape rounds out the sharp corner of the upper compartment of housing 3, to produce a more efficient airflow through the first airflow channel 26.

28. Particulate filter-condensate separator,

The particulate filter-condensate separator 28, Includes filter frame 28a, first filter screen 28b, second filter screen 28c, first & second filter screen surrounds 28d, first and second filter screen hinges 28e, and filter frame handle 28f. The particulate filter-condensate separator 28, is designed to be removable for cleaning.

Additionally, the particulate filter-condensate separator 28, prevents condensate C, from entering the first airflow channel 26, and simultaneously filters particulate from entering the second airflow channel 37.

First filter screen 28b, and second filter screen 28c, are enlarged to provide increased filtering for removing particulate derived from an airflow source CD.

28a. Filter frame,

The filter frame 28a, contains the filter frame handle 28f, and first and second filter screen hinges 28e, which is hinged to open for cleaning the first filter Screen 28b, and second filter screen 28c, when removed from the upper compartment of housing 3, and closed when inserted into the filter frame upper guide 29, and filter frame lower guide 30, of the upper compartment of housing 3. Additionally, the filter frame 28a, contains the condensate weep holes 28g, for draining away any condensate C, which may flow from the particulate filter-condensate separator 28.

28b. First filter screen,

The first filter screen 28b, is located within the particulate filter-condensate separator 28, and is located on the windward side and is attached to the first and second filter screen surround 28d, which is attached to the filter frame 28a.

The first filter screen 28b, receives the airflow 25, coming from the first airflow channel 26.

28c. Second filter screen,

The second filter screen 28c, is located within the particulate filter-condensate separator 28, and is located on the leeward side and is attached to the second filter screen surround 28d, which is attached to the filter frame 28a. The second filter screen 28c, is adjacent to the first filter screen 28b, and receives the airflow 25, coming from the first filter screen 28b.

28d, First and second filter screen surrounds,

The first and second filter screen surrounds 28d consist of a framework for attaching and supporting the first filter screen 28b, and second filter screen 28c. The first and second filter screen surrounds 28d are connected to the filter frame 28a, with first and second filter screen hinges 28e, and fold together for inserting into the upper compartment of housing 3, and unfold when removed for cleaning.

28e, First and second filter screen hinges,

The first and second filter screen hinges 28e, connects the first and second filter screen surrounds 28d, to the filter frame 28a, and allows the first filter screen 28b, and second filter screen 28c, to be folded opened for cleaning and folded closed for inserting into the filter frame upper guide 29, and filter frame lower guide 30, of the upper compartment of housing 3.

28f, Filter frame handle,

The filter frame handle 28f, is attached to the filter frame 28a, for its insertion into and removal from the filter frame upper guide 29, and filter frame lower guide 30, within the upper compartment of housing 3.

28g, Condensate weep holes,

The condensate weep holes 28g, are located within the lower side of the filter frame 28a, of the particulate filter-condensate separator 28, and receives condensate C, that may inadvertently flow into the first and second filter screens 28b, and 28c, of the particulate filter-condensate separator 28. The condensate weep holes 28g, drains the condensate C-1, into the sloped basin floor 21, for disposal through the condensate drain 22.

29. Filter frame upper guide,

The filter frame upper guide 29, is located within the upper compartment of housing 3, for receiving and securing the filter frame 28a, when it is inserted into its operational position inside the upper compartment of housing 3.

The filter frame upper guide 29, works jointly with the filter frame lower guide 30, to secure the filter frame 28a.

30. Filter frame lower guide,

The filter frame lower guide 30, is located within the upper compartment of housing 3, for receiving and securing the filter frame 28a, when it is inserted into its operational position inside the upper compartment of housing 3.

The filter frame lower guide 30, works jointly with the filter frame upper guide 29, to secure the filter frame 28a. Additionally, the filter frame lower guide 30, has a sloped bottom of filter frame 32, tapered downward toward the condensate drain 22, to produce a fit into the sloped insert key 33, which allows the filter frame 28a, to be “keyed” into the filter frame upper guide 29, and filter frame lower guide 30.

31. Sloped lower guide,

The sloped lower guide 31, is tapered toward the condensate drain 22, on the leeward side of the filter frame 28a, to serve as a fit of the sloped bottom of filter frame 32, which matches with the Top of the sloped lower guide 31, to match with a sloped insert key 33, to insure proper placement of the filter frame 28a, within the upper and lower guides 29 and 30.

32. Sloped bottom of filter frame,

The sloped bottom of filter frame 32, is tapered to serve as the inserting half of the sloped insert key 33, to match the sloped lower guide 31. The sloped insert key 33, insures proper insertion of the filter frame 28a, into the filter frame upper guide 29, and filter frame lower guide 30.

The sloped bottom of filter frame 32, matches with the sloped lower guide 31, to insure proper insertion and for securing the filter frame 28a, into the filter frame upper guide 29, and filter frame lower guide 30.

33. Sloped inserting key,

The sloped insert key 33, matches the sloped bottom of filter frame 32, to the sloped lower guide 31, to provide a correct insertion and secure placement of the filter frame 28a, into the filter frame upper guide 29, and filter frame lower guide 30, within the upper compartment of housing 3.

34. Gate hinge attachment,

The gate hinge attachment 34, connects the retaining gate 12, to the side wall of housing 5/6.

35. Airflow deflector,

The airflow deflector 35, Is an airflow directional guide within the second airflow channel 37, with its lower end connected to the filter frame lower guide 30, with its body projected upward and away from the particulate filter-condensate separator 28, at about a 45 degree angle to direct airflow 25, upward into the second airflow channel 37. Additionally, the airflow deflector 35, prevents airflow 25, from entering the condensate drain 22.

Additionally, the upper end of the Airflow Deflector 35, is higher than the lower end of the second airflow directional vane 38, and the airflow deflector 35 diverts the airflow 25, upward before the airflow 25, reaches the lower end of the second airflow directional vane 38, and directs the airflow 25, past the lower end of the second airflow directional vane 38, thus, preventing the airflow 25, from entering the condensate drain 22.

The Airflow deflector 35, is located between the lower end of the second airflow directional vane 38, and the filter frame 28a, to deflect upward airflow 25, before it reaches the opening at the condensate drip edge 49.

36. Third directional vane, (alternate ports)

The third directional vane 36, Is installed in the upper side of the second airflow channel 37, when an optional primary airflow Port 43, is installed in the upper compartment floor/lower compartment ceiling 20, to allow a downward exit direction of the exhaust pipe 45, configuration.

37. Second airflow channel,

The second airflow channel 37, is located in the upper compartment of housing 3, on the Leeward side of the particulate filter-condensate separator 28, and above the sloped basin floor 21, and below the primary airflow exit port 43. Within the second airflow channel 37, is the second airflow directional vane 38, the secondary airflow exit port 42, and the airflow deflector 35.

The second airflow channel 37, receives airflow 25, from the particulate filter-condensate separator 28 and directs the airflow 25, upward through the Primary Airflow exit port 43, or through the secondary airflow port 42, depending on the position of the diverter door with sloped top 44.

Additionally, the second airflow channel 37, serves as a downward passageway for condensate C-1, when flowing through the primary airflow exit port 43, with the diverter door with sloped top 44, in the down position.

38. Second airflow directional vane,

The second airflow directional vane 38, is located within the second airflow channel 37, the second airflow directional vane 38, turns the latterly flowing airflow 25, leaving the particulate filter-condensate separator 28, to an upward direction.

The lower end of the second airflow directional vane 38 extends below the airflow deflector 35, with the airflow deflector 35, located between the lower end of the second airflow directional vane 38 and the lower end of the particulate filter-condensate separator 28, resulting in the airflow deflector 35, blocking the airflow 25, from entering the condensate drain 22.

Additionally, the second airflow directional vane 38, does not reach all the way to the filter frame lower guide 30, resulting in a condensate opening at the lower end of the second airflow directional vane 38, which is adjacent to the condensate drip edge 49, which allows an open space for the condensate C-1, to flow to the sloped floor basin 21, while preventing the entry of airflow 25, into the condensate drain 22.

39. Access openings,

The access openings 39, are located on the front wall of upper compartment 11, the access openings 39, are for entering the upper compartment of housing 3, for testing, cleaning and inspections. The access openings 39, are enclosed with removable viewing windows 40, which provide an air-proof seal when installed.

40. Viewing windows,

The removable viewing windows 40, covers the access openings 39 with an air-tight seal when positioned in place.

The viewing windows 40, allow interior observation of the upper compartment of housing 3, without requiring removal from the access openings 39. The visual windows 40, are removable for interior inspections and maintenance of the upper compartment of housing 3.

41. Airflow pressure manometer/alarm,

the airflow pressure monometer/alarm 41, is attached to the front wall of upper compartment 11, for providing data and monitoring operational conditions within the lower compartment of housing 2, upper compartment 3, and the airflow exhaust pipe 45. Additionally, the airflow pressure manometer/alarm 41, monitors the operational conditions of the airflow source CD.

42. Secondary airflow exit port,

One of two exhaust ports, is the secondary airflow exit port 42, located on the front wall of upper compartment 11, the secondary airflow exit port 42, allows airflow 25, to be directed into an Alternate space by blocking the same airflow 25, from entering the primary airflow exit port 43, with rotation of the diverter door with sloped top 44. The secondary airflow exit port 42, provides an opening to allow airflow 25, to be routed into an alternate space-when desired by the operator.

43. Primary airflow exit port,

One of two exhaust ports, is the primary airflow exit port 43, located on the top wall of housing 8, and being the connection point of the airflow exhaust pipe 45, the primary airflow exit port 43, allows the airflow 25, to be directed into the airflow exhaust pipe 45, by blocking the same airflow 25, from entering the secondary airflow exit port 42, with rotation of the diverter door with sloped top 44. The primary airflow exit port 43, provides an opening to allow airflow 25, to be routed into the airflow exhaust pipe 45, when desired by the operator.

44. Diverter door with sloped top,

The diverter door with sloped top 44, is located between the secondary airflow exit port 42, and the primary airflow exit port 43, with the diverter door hinge 44b, positioned between the primary airflow exit port 43, and the secondary airflow exit port 42, to allow rotation between ports.

When the diverter door with sloped top 44, is in diverter door-down position 44d, the secondary airflow exit port 42, is closed, and the primary airflow exit port 43, is open. When the diverter door with sloped top 44, is in the down position, it allows falling condensate C, to flow into the second airflow channel 37 as condensate C-1.

When the diverter door with sloped top 44, is in diverter door-up position 44e, the primary airflow exit port 43, is closed and the secondary airflow exit port 42, is open. When the diverter door with sloped top 44, is in the up position, it directs falling condensate C, to flow into the condensate drain channel 48, as Condensate C-2.

44a. Diverter door handle,

The diverter door handle 44a, is used by the operator to manually or mechanically positioning the diverter door with sloped top 44, in either the diverter door, up position 44e, which blocks the primary airflow exit port 43, or the diverter door, down position 44d, which blocks the secondary airflow exit port 42.

44b. Diverter door hinge,

The diverter door hinge 44b, connects the diverter door with sloped top 44, to the upper compartment of housing 3, between the secondary airflow exit port 42, and the primary airflow exit port 43, and oscillates to close the primary airflow exit port 43, or alternately, to close the secondary airflow exit port 42.

44c. Diverter door air seal,

The diverter door air seal 44c, prevents leakage of condensate C, or air when the diverter door with sloped top 44, is in a closed position of either the primary airflow exit port 43, or the secondary airflow exit port 42.

44d. Diverter door-down position,

The diverter door-down position 44d, makes the primary airflow exit port 43, to be open and the secondary airflow exit port 42, to be closed. Condensate C, flows downward from the airflow exhaust pipe 45, through the primary airflow exit port 43, into the second airflow channel 37, and into the sloped basin floor 21, as airflow 25, flows upward through the primary airflow exit port 43. Into the airflow exhaust pipe 45.

44e. Diverter door-up position,

The diverter door, up position 44e, makes the secondary airflow exit port 42, to be open and the primary airflow exit port 43, to be closed. Condensate C, flows downward from the airflow exhaust pipe 45, to the diverter door with sloped top 44, with a tapered top which direct the condensate C, latterly and downward into the condensate drain channel 48.

Additionally, airflow 25, is directed out through the secondary airflow exit port 42, by blocking the primary airflow exit port 43.

45. Airflow exhaust pipe,

The airflow exhaust pipe 45, connects to the top wall of housing 8, and is positioned up-stream of the primary airflow exit port 43.

Additionally, the airflow exhaust pipe 45, receives airflow 25, from the second airflow channel 37, through the primary airflow exit port 43. and conveys the airflow 25, to a termination point.

46. Airflow fan,

The airflow fan 46, is located within the housing 1, or within the airflow exhaust pipe 45, for moving airflow 25, through the housing 1, into the exhaust pipe 45, when the diverter door-down position 44d, is positioned to close the secondary airflow exit port 43, thus, resulting in the primary airflow exit port 43, being open. The airflow Fan 46, additionally, serves as an auxiliary air moving device to increase efficiency of other airflow fans.

47. Diverter assembly,

The diverter assembly 47, comprises secondary airflow exit port 42, primary airflow exit port 43, diverter door with sloped top 44, diverter door handle 44a, diverter door hinge 44b, diverter door air seal 44c, diverter door-down position 44d, diverter door-up position 44e

48. Condensate drain channel

The condensate drain channel 48, Receives condensate C, from the exhaust pipe 45, when the diverter door with sloped top 44, is in the up position and blocks condensate C, from entering the second airflow channel 37.

The tapered top of the diverter door with sloped top 44, sends the condensate C, over and downward to the condensate drain channel 48, which has an upward opening located adjacent to the lower edge of the tapered top of the diverter door with sloped top 44. With the diverter door-up position 44e.

The diverter door-up position 44e, closes off the primary airflow exit port 43, thus preventing condensate C, from flowing downward through and preventing airflow 25, from flowing upward through.

49. Condensate drip edge,

The condensate drip edge 49, Is located at the lower tip of the second airflow directional vane 38, and located above the sloped basin floor 21, and located at a lower point than the airflow deflector 35, and located behind the airflow deflector 35, resulting in the airflow deflector 35, being between the condensate drip edge 49, and the particulate filter-condensate separator 28.

The position of the condensate drip edge 49, and relationship to the airflow deflector 35, allows condensate C-1, to drip downward into the sloped basin floor 21, while preventing airflow 25, from entering the sloped basin floor 21.

C. Condensate (within airflow exhaust pipe, 37)

Condensate C, within the exhaust pipe 45, is referred to as condensate C. As the condensate C, passes through the primary airflow exit port 43, and flows into the second airflow channel 37, the condensate C, becomes condensate C-1. When the condensate C, passes into the condensate drain channel 48, the condensate C, becomes condensate C-2.

Condensate C, is created when warm and moist airflow 25, leaves the airflow source CD, and is sent up through the exhaust pipe 45, and as the temperature changes, condensation takes place and converts the gas phase to a liquid phase. The liquid phase is known as condensate C. The condensate C, flows back down the exhaust pipe 45, and can enter the airflow source CD, or the airflow flexible vent duct 17, and fill with condensate C, and block the airflow 25, causing mechanical problems.

C-1. Condensate, (within second airflow channel, 37)

The condensate C, becomes Condensate C-1, when the diverter door with sloped top 44, is in the down position, resulting in the primary airflow exit port 43, being open and clear to allow condensate C, from the airflow exhaust pipe 45, to flow into the second airflow channel 37, thus, the condensate C, becomes condensate C-1, as it enters the second airflow channel 37, through the primary airflow exit port 43. Condensate C-1, flows downward through the second airflow channel 37.

C-2 Condensate, (within condensate drain channel, 48)

The condensate C, becomes condensate C-2, when the diverter door with sloped top 44, is in the up position, resulting in the secondary airflow exit port 42, being open and clear to allow condensate C, from the airflow exhaust pipe 45, to flow into the condensate drain channel 48, thus, the condensate C, becomes condensate C-2, as it enters the condensate drain channel 48.

When the diverter door with sloped top 44, is in the up position, the primary airflow exit port 43, is blocked from receiving falling condensate C, from the airflow exhaust pipe 45, and the falling condensate C, from the airflow exhaust pipe 45, lands on the tapered top of the diverter door with sloped top 44, thus directing the condensate C, to flow laterally and downward into the top opening of the condensate drain channel 48, at this point condensate C, becomes condensate C-2 and flows through the condensate drain channel 48, down to the condensate drain 22.

Condensate C-2, flows through the condensate drain channel 48, and condensate C-1, flows through the primary exhaust airflow port 43, and into the second airflow channel 37.

CD. Airflow source,

The airflow source CD, represents air with contamination of particulate, high moisture content, or other polluting, impure substances. The airflow source CD, may be in a pressurized or non-pressurized state, it may be in a natural or unnatural state and may be derived from below the earth's surface, above the earth's surface.

Additionally, the air may be derived from a man-made machine, including, but not limited to items such as air conditioners, wells, pumps, buildings, dryers, processors, compressors, and general extraction equipment.

An example of an airflow source CD is a Clothes Dryer, which produces high temperature exhaust airflow with a high percentage of moisture within. This warm, moist, particulate (lint) laden air is forced through its vent system causing condensate to form and fall back into the dryer causing damage, additionally, lint will mix with the condensate causing blockage and damage.

### CONCLUSION, RAMIFICATIONS AND SCOPE

Thus the reader will see that at least one embodiment of this condensate and particulate separator within an air vent provides a more reliable and efficient airflow exhaust system.

Because much of an exhaust air vent is hidden from sight inside finished walls, particulate, such as lint and condensate blockage problems can build up and cause serious damage to an exhaust airflow producing machine if it over-heats and starts a fire. This invention addresses the problems that can cause particulate/condensate blockage in the exhaust vent with additional particulate filtration and simultaneously diverting falling condensate away from the airflow path to a sanitary disposal.

The blending of condensate and particulate within an exhaust airflow outlet pipe can also support mold growth, which can lead to health issues within a building.

It is within the scope of this invention.

To provide a removable final particulate filter unit that drains off any collected condensate which may enter the filter.

To provide separation of exhaust airflow from falling condensate and direct the condensate to a separate exit destination for removal from the exhaust vent system.

For removing condensate (water) from the gaseous fluid exhaust system before it reaches an exhaust airflow producing machine.

To be sized for installing within a typical two-by-four inch stud wall to conserve floor space and provide unrestricted exhaust airflow passage through the system.

To secure an incoming flexible airflow vent pipe within the housing for conserving floor space and providing efficient exhaust airflow passage by containing the flexible vent pipe in a non-kinking configuration.

To be constructed of substantially fire-resistant materials.

To direct the filtered exhaust airflow through an outlet pipe to the outside atmosphere or optionally, to an interior atmosphere exit port, subject to an operator's preference.

To include a monitor for detecting, recording, displaying and giving warning to unacceptable exhaust airflow conditions within the exhaust airflow vent system.

For providing access openings within the housing for interior maintenance and diagnostic inspections.

To include removable/replaceable windows for viewing internal conditions during operational periods while keeping the housing substantially airtight and provide closure for the access openings during operation.

For protecting the environment by removing particulate, such as lint from exhaust airflow prior to its entering the atmosphere.

For providing a fan to draw exhaust airflow when used for airflow removal from locations above and below ground, building interior or exterior.

While my above description contains many specifications, these should not be construed as limitations on the scope of the embodiments, but rather as an exemplification of one or several preferred embodiments thereof. Many other variations are possible. Accordingly, the scope should be determined not by the embodiments illustrated, but by the appended claims and their legal equivalents.

### LIST OF REFERENCE NUMERALS

1. Housing
2. Lower Compartment of Housing
3. Upper Compartment of Housing
4. Bottom Wall of Housing
5. Left Side Wall of Housing
6. Right Side Wall of Housing
7. Rear Side Wall of Housing
8. Top Wall of Housing
9. Housing Attachment Flange
10. Attachment Holes of Housing Flange
11. Front Side Wall of Upper Compartment
12. Retaining Gate in Closed Position
13. Retaining Gate in Open Position
14. Retaining Gate Adjustable Cross Bars
15. Retaining Gate Hinges
16. Retaining Gate Latch
17. Airflow Flexible Vent Duct
18. Housing Vent Knockouts, Left, Right and Bottom
19. Vent Duct Adapter, Round Transition to Rectangular
20. Upper Compartment Floor/Lower Compartment Ceiling
21. Sloped Basin Floor
22. Condensate Drain
23. Condensate Drain Trap
24. Condensate Disposal Hose
25. Airflow
26. First Airflow Channel
27. First Airflow Directional Vane
28. Particulate filter-condensate separator
28a. Filter Frame
28b. First Filter Screen
28c. Second Filter Screen
28d. First and Second Filter Screen Surrounds
28e. First and Second Filter Screen Hinges
28f. Filter Frame Handle
28g. Condensate Weep Holes
29. Filter Frame Upper Guide
30. Filter Frame Lower Guide
31. Sloped Lower Guide
32. Sloped Bottom of Filter Frame
33. Sloped Insert Key
34. Gate Hinge Attachment
35. Airflow Deflector
36. Third Directional Vane, Alternate Ports
37. Second Airflow Channel
38. Second Airflow Directional Vane
39. Access Openings
40. Viewing Windows
41. Airflow Pressure Manometer/Alarm
42. Secondary Airflow Exit Port
43. Primary Airflow Exit Port
44. Diverter Door with Sloped Top
44a. Diverter Door Handle
44b. Diverter Door Hinge
44c. Diverter Door Air Seal
44d. Diverter Door-Down Position
44e. Diverter Door-Up Position
45. Airflow Exhaust Pipe
46. Airflow Fan
47. Diverter Assembly (42, 43, 44, 44a, 44b, 44c, 44d, 44e)
48. Condensate Drain Channel
49. Condensate Drip Edge
C. Condensate (originating within airflow exhaust pipe)
C-1. Condensate (within second airflow channel, 37)
C-2. Condensate (within condensate drain channel, 48)
CD. Airflow Source

I claim:

1. A housing interconnected with an airflow source for receiving contaminated airflow produced by said airflow source, said housing containing a particulate filter-condensate separator for filtering particulate and separating condensate from said airflow, and said housing is attached to said airflow source for receiving said airflow produced by said airflow source, for filtering and disposing said particulate from said airflow, for separating and disposing said condensate from said airflow, for separating said particulate from said condensate within said airflow, for making said airflow substantially free of said particulate and said condensate, for channeling said particulate and said condensate free airflow through a diverter assembly, into a specified airflow exhaust pipe or an optional destination, and
said housing for separating said condensate from said particulate contained within said airflow, and
comprising a particulate filter-condensate separator to separate and dispose of said particulate from said airflow, and comprising said diverter assembly to separate and dispose said condensate from said airflow into a condensate drain, and
separately dispose said particulate through said particulate filter-condensate separator, and separately dispose said condensate through said condensate drain, and separately dispose particulate and condensate free airflow, and
said airflow exhaust pipe, being configured to be of rectangular shape and sized to install within a wall cavity and accommodate total airflow capacity delivered from said airflow source.

2. Said housing containing a particulate filter-condensate separator, with connected air flow channels positioned within an substantially enclosed airtight compartment of said housing for removing said particulate from said airflow being received from said airflow source, and
comprising means for separating said particulate from said airflow, and
for separating said condensate from said airflow, and
for separating said particulate from said condensate, and
for separating said condensate from said particulate, and
for separating said airflow from said condensate and
for separating said airflow from said particulate, and
for removing said airflow from said housing through a diverter assembly, and
for removing said particulate from said housing through said particulate filter-condensate separator, and
for removing said condensate from said housing through said condensate drain, and
said airflow conditioned to be made free of said condensate and to be made free of said particulate prior to disposal of said airflow through said diverter assembly.

3. Said housing comprising said particulate filter-condensate separator, further comprising an intake channel with a first end connected to said airflow source for receiving said airflow and further comprising a second end of said intake channel for delivering said airflow into and through said particulate filter-condensate separator for removing said particulate from said airflow, and
said diverter assembly for directing after filtered airflow to said airflow exhaust pipe, or optionally directed to a secondary outlet and
for directing said condensate to be channeled to said condensate drain for disposal, and
said housing comprising an airflow fan for moving said airflow from said airflow source through said housing, and
said airflow fan for moving said airflow from said airflow source into and through said housing.

4. The housing of claim 1, further comprising a lower compartment, substantially open to accommodate and organize a flexible vent duct which receives said airflow from said airflow source, and
an upper compartment, substantially airtight for receiving said airflow from said flexible vent duct into an airflow channel, which directs said airflow through said particulate filter-condensate separator for removing said particulate from said airflow, and
said particulate filter-condensate separator collects and drains off any inadvertent condensate which may enter said particulate filter-condensate separator, and
said particulate filter-condensate separator comprises an enlarged folding double screen for an enlarged filtration surface, and
said housing comprises a second airflow channel, within said upper compartment for receiving said airflow from said particulate filter-condensate separator and directs said airflow into said diverter assembly, which directs said airflow to a selected exit port for removal, and
an airflow fan located within said housing or located within said airflow exhaust pipe for moving said airflow through said housing, said fan, located within said upper compartment for moving airflow from an airflow source such as designated space below ground, above ground, building interior or one or more exhaust airflow producing machines into said housing, for removing particulate and condensate from said airflow, and
said airflow fan, additionally moves airflow from said airflow source, such as one or more exhaust airflow producing machine into said housing for removing particulate and condensate from said airflow.

5. The housing of claim 1, comprising said upper compartment, which is substantially closed, comprising a monitor/alarm for indicating and reporting airflow conditions within said housing, comprising access openings to allow access within said upper compartment of said housing for inspections and maintenance, comprising viewing windows that serves for viewing interior operations of said upper compartment and are sized to cover and seal said access openings, which are located in the said upper compartment and
said housing, comprising said lower compartment, substantially open, which comprises a hinged retaining gate for securing said flexible vent duct within said lower compartment, and
said upper compartment, comprising a first airflow channel, comprising a particulate filter-condensate separator, comprising a second airflow channel, comprising a diverter assembly, and
said upper compartment comprising a forward extending depth dimension in relationship to said lower compartment, and
said upper compartment sized to accommodate said particulate filter-condensate separator, said airflow fan, said access openings, said viewing windows, said monitor/alarm, said airflow channels, said diverter assembly, said first airflow channel, said second airflow channel, and
said upper compartment rear wall being an extension and the same plane as said lower compartment rear wall, and said upper compartment front wall extending forward further than said lower compartment front wall resulting in an extended front to rear length of said upper compartment in relationship to said lower compartment front wall, and
said diverter assembly comprising a primary airflow exit port, a secondary airflow exit port, diverter door with sloped top, diverter door handle, diverter door hinge, diverter door seal, diverter door-down position and diverter door-up position, comprising means to direct said condensate originating from said airflow exhaust pipe into said condensate drain for disposal, and
comprising means to direct said airflow into said primary airflow exit port or optionally direct said airflow into said secondary airflow exit port, and
said diverter assembly, being located within said upper compartment and located on the leeward side of said particulate filter-condensate separator.

6. The housing of claim 1, comprising said particulate filter-condensate separator comprising a filter frame, first filter screen, second filter screen, first and second filter screen surrounds, first and second filter screen hinges, filter frame handle, and condensate weep holes, being located within said upper compartment for receiving said airflow originating from said airflow source, said airflow being in a particulate laden state, said particulate filter-condensate separator being positioned to receive and clean said airflow prior to said airflow entering said diverter assembly, and
said airflow passes through said particulate filter-condensate separator, resulting in said airflow being cleaned of said particulate, and
said particulate filter-condensate separator comprising means to collect and dispose said condensate which inadvertently enters said particulate filter-condensate separator, and
said particulate filter-condensate separator comprising means to be insert-able, affixed and removable into said upper compartment in an airtight configuration.

7. The housing of claim 4, comprising said lower compartment is dimensioned to be installed within the area of a typical stud wall and maintain dimensions so as not to restrict said airflow produced by said airflow source through a four inch round flexible vent duct and provide storage for said flexible vent duct within said lower compartment, and provide means to organize and contain said flexible vent duct, and
said lower compartment being substantially open comprising a rotating gate to secure said flexible vent duct within said lower compartment.

8. The airflow fan of claim 3, located within said housing or optionally located within said airflow exhaust pipe may serve as the sole provider for moving airflow from said airflow source through said housing, or
said airflow fan may serve as a booster fan in support of another airflow fan, which may be associated with said airflow source.

9. The housing of claim 1, may be interconnected and function with one or more said airflow sources, which may include an exhaust airflow producing machine, space below the earth's surface, and space above the earth's surface including space within a building's interior.
